(19) United States
(12) Patent Application Publication
(10) Pub. No.: US 2010/0278361 A1
(43) Pub. Date: Nov. 4, 2010

(54) Configurations And Methods For Broadband Planar Magnetic Induction Transducers

(75) Inventors: Vahan Simidian, II, Newport Beach, CA (US); Dragoslav Colich, Costa Mesa, CA (US)

Correspondence Address: FISH & ASSOCIATES, PC;ROBERT D. FISH, 2603 Main Street, Suite 1000, Irvine, CA, 92614-6232, US

(73) Assignee: HPV TECHNOLOGIES, INC., Costa Mesa, CA (US)

(21) Appl. No.: 12/602,917

(22) PCT Filed: Jun. 19, 2008
(86) PCT No.: PCT/US08/07726

§ 371 Date: Jul. 26, 2010

Related U.S. Application Data
(60) Provisional application No. 60/945,247, filed on Jun. 20, 2007.

(51) Int. Cl. H04R 1/00

(52) U.S. Cl. 381/150; 381/396

(57) ABSTRACT

Contemplated planar magnetic induction transducers comprise a driver portion that provides a static magnetic field and a dynamic magnetic field to an electrically conductive sound producing membrane to thereby induce a current in the membrane that operates as a voice coil. Most typically, the dynamic magnetic field is produced by a coil that surrounds the magnet, and the membrane is floating above the driver portion. In especially preferred aspects, the sound producing membrane is physically independent from the driver portion and can be separately installed from the driver portion.

This application claims priority to our copending U.S. provisional application with the Ser. No. 60/945247, which was filed Jun. 20, 2007.

### FIELD OF THE INVENTION

The field of the invention is transducers, and especially induction transducers.

### BACKGROUND OF THE INVENTION

Many different driving mechanisms in various transducers are known to create sound by actuating a membrane. For example, most conventional speakers, including cone speakers and dome speakers, employ a voice coil rigidly attached to a movable membrane, wherein the voice coil is disposed in the magnetic field of a static magnet. Current running through the voice coil then interacts with the magnetic field of the static magnet to actuate the membrane. Sound reproduction in these speakers is often excellent. However, such speakers have several limitations. First, driving mechanism often requires high power consumption given that a fairly heavy voice coil must also be moved. Also, when such speakers are miniaturized (e.g., for use in electronic devices, including cell phones, PDAs, computers, etc.), the sound quality decreases and production costs often significantly increase. Still further, integration of such small speakers into an electronic device in an automated production process is frequently difficult.

Similarly, U.S. Pat. No. 4,468,530 describes a broadband planar speaker with a voice coil rigidly connected to a flat membrane, and U.S. Pat. No. 5,764,784 describes a broadband planar speaker with a voice coil rigidly connected to a circular flat membrane. Although both speakers typically provide adequate sound quality, sound pressure levels are often relatively modest, and heat dissipation at higher power levels frequently becomes problematic. Still further, as the coil is rigidly attached to the membrane, the weight of the membrane often limits performance of such speakers.

In still further known driving mechanisms, as for example described in U.S. Pat. No. 6,389,145, a magnetic buzzer has a magnetically conductive membrane that is magnetized by contact with a static magnet and vibrated by a magnetic field induced by a drive coil. In another known magnetic buzzer, JP 2003339100, a drive coil induces a current in an electrically conductive ring attached to the membrane. The induced current creates a magnetic field which then interacts with the magnetic field of a nearby magnet and causes vibrations in the membrane. Such configurations are often easier to manufacture and can be implemented in small devices. Additionally, these magnetic buzzers often have improved power efficiency. However, magnetic buzzers have a narrowband output (typically between 2-5 kHz bandwidth) and therefore have only limited application as a sound producing transducer.

In less conventional approaches, as described in U.S. Pat. Nos. 5,062,140 and 6,359,996, a dome speaker uses a drive coil, static magnet, and conductive ring attached to a cone-shaped membrane. When a current runs through the drive coil, a magnetic field is induced, which then induces a current in the conductive ring. The induced current then interacts with the static magnet to vibrate the membrane. Similarly, as shown in U.S. Pat. Nos. 6,175,637 and 6,542,617 the need for a voice coil is eliminated by inducing current in a conductive ring, which is rigidly attached to the base of a cone speaker. While such approach is conceptually quite attractive, various limitations still remain. First, the mass of the conductive ring, although typically less than a voice coil, is still large relative to the membrane and the audio signal is therefore often compromised. Moreover, as the conductive ring is parallel to the axis of sound emission, the mass of the ring does not contribute to the sound generation and is as such “dead weight”. Second, heat dissipation is problematic and often limits such speakers to the upper acoustic spectrum (e.g., above 2-5 kHz). Third, integration of such small speakers into electronic devices in an automated production is difficult.

Therefore, while numerous configurations and methods of speakers are known in the art, all or almost all of them suffer from one or more disadvantages. Consequently, there is still a need to provide improved configurations and methods to allow for automated manufacturing of broadband transducers with high sound quality.

### SUMMARY OF THE INVENTION

The present invention is directed to configurations, methods and devices in which a transducer comprises a driver portion and a preferably flat and electrically conductive sound producing portion that is typically uncoupled from the driver portion. The driver portion is then placed relative to the sound producing portion to allow induction of a current in the sound producing portion in lieu of a voice coil on the sound producing portion. In preferred aspects, the driver portion has at least a voice coil and most preferably a permanent magnet, while the sound producing portion comprises an electrically conductive membrane, typically configured as a planar membrane that is movably coupled to a frame such that the entire membrane can move relative to the frame to thereby produce an audible signal or measurable current in the voice coil.

Therefore, in one aspect of the inventive subject matter, a broadband transducer has a floating conductive and rigid membrane having a sound producing area. Contemplated transducers further include a stator assembly with a magnet, wherein the stator assembly is positioned relative to the membrane such that at least part of the sound producing area is disposed in a magnetic field of the magnet. Such transducers still further include a voice coil that is positioned relative to the magnet such that when current flows through the coil, a current is induced in at least part of the sound producing area in an amount effective to produce an audible broadband signal.

Most typically, the stator assembly comprises a stator housing coupled to the magnet, and/or the magnet is disposed within an annular space formed by the coil. It is further preferred that the coil is coupled to or at least partially embedded within a printed circuit board (e.g., the coil may be formed by a plurality of conductive elements in a plurality of layers forming the printed circuit board). Similarly, the magnet may be coupled to or at least partially embedded within the circuit board and will typically include a plurality of openings. While not limiting to the inventive subject matter, it is generally preferred that the transducer comprises a frame to which the membrane is coupled.

Consequently, and viewed from a different perspective, a method of manufacturing an intermediate in the production of an electronic device having a broadband transducer that includes a driver portion and a sound producing portion will include a step of providing a printed circuit board having a plurality of conductive traces. In a further step, a driver portion is then electronically coupled without the sound producing portion to one or more conductive traces of the printed circuit board.

In especially preferred aspects, driver portion comprises a prefabricated voice coil, which is most preferably at least partially embedded in the circuit board. Alternatively, the voice coil is formed by a plurality of conductive elements in a plurality of layers forming the printed circuit board. Regardless of the manner of forming the voice coil it is preferred that the voice coil circumferentially encloses a magnet. Thus, in at least some of contemplated methods, the driver portion will include a voice coil, a magnet, and a stator housing coupled to each other. The sound producing portion is then placed in proximity to the driver portion to thereby form a broadband planar magnetic induction transducer. Most preferably, the sound producing portion comprises a conductive metallic membrane that may or may not form part of a housing of the device.

Therefore, especially contemplated electronic devices will comprise a broadband transducer with a driver portion and a sound producing portion, wherein the driver portion and sound producing portion are independent elements in the device. In particularly preferred devices, the driver portion is configured and positioned relative to the sound producing portion such that the driver portion allows induction of a current in the sound producing portion to thereby effect an audible broadband signal. A printed circuit board with a plurality of conductive traces is further included, and at least one of the traces is electronically coupled to the driver portion. Most typically, contemplated broad band transducers have a frequency response with a deviation of equal or less than 12 db over a range of between 100 Hz and 10 kHz.

Similar to contemplated transducers and methods above, it is especially preferred that the driving portion is coupled to or at least partially embedded in the circuit board. Where desired, the sound producing portion may be coupled to the housing of the device. Among things, contemplated devices may be configured to operate as a microphone, a speaker, a telephone, a vibrometer, a dynamic force gauge, or a sonar transducer.

Various objects, features, aspects and advantages of the present invention will become more apparent from the following detailed description of preferred embodiments of the invention, along with the accompanying drawing.

### BRIEF DESCRIPTION OF THE DRAWING

FIG. 1 is a perspective view of a vertical cross section illustrating one exemplary broadband transducer according to the inventive subject matter.

FIG. 2 is a perspective side view of the transducer of FIG. 1.

FIG. 3 is a perspective bottom view of the transducer of FIG. 1.

FIG. 4 is a perspective top view of the transducer of FIG. 1.

### DETAILED DESCRIPTION

The inventors have discovered that broadband induction transducers, and particularly planar magnetic broadband induction transducers with a flat, rigid, and conductive sound producing portion can be manufactured in an extremely simple and effective manner. Thus, contemplated transducers not only have a highly simplified architecture, but also allow for automated and integrated formation of a transducer in an electronic device.

Most advantageously, at least part of the transducer can be formed by components on a printed circuit board. Still further, as the speakers according to the inventive subject matter employ induction of a current in the sound producing area of the membrane, the voice coil can be entirely omitted on the membrane and so allows for separate installation. Thus, the membrane may be supplied by a portion of an electronic device that is entirely independent from the circuit board. Regardless of the manner of manufacture and specific assembly, it should be appreciated that where contemplated transducers are operated as a speaker, the speaker will be a broadband speaker that produce sound between 100 Hz (and even lower) and 20 kHz (and even higher). In most configurations, such speakers will have a frequency response over a range of between 100 Hz and 10 kHz with a deviation of equal or less than 12 db, more typically equal or less than 10 db, and most typically equal or less than 8 db. Therefore, a beeper (or magnetic buzzer) is expressly excluded from the meaning of the term broadband speaker.

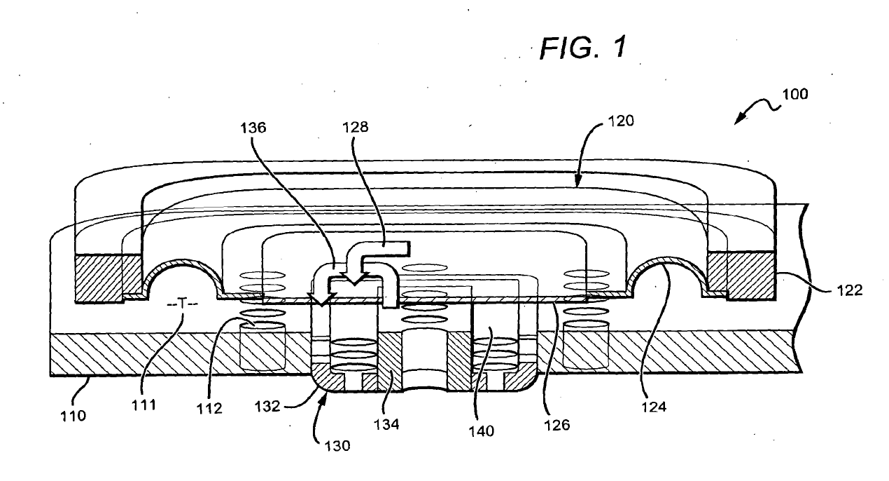

One exemplary transducer according to the inventive subject matter is schematically depicted in FIG. 1 where broadband transducer 100 is configured to operate as a broadband speaker (and optionally microphone), and where the broadband transducer forms part of an electronic device (e.g., cellular phone, PDA, or laptop computer; not shown in detail here). The electronic device includes a printed circuit board 110 (having a plurality of conductive traces 111 schematically depicted as T). A plurality of transverse openings 112 are provided in the board 110 to allow for sound and/or heat to travel across the board. A sound producing portion (here: configured as membrane assembly 120) is located in a position above the board 110. It should be appreciated that the sound producing portion does not need to be physically attached to the board. In most aspects of contemplated speakers, the membrane assembly 120 comprises a mounting structure 122 (here: configured as a frame) to which a flexible baffle 124 is coupled to allow translational movement (rather than deformation) of the conductive and rigid membrane 126. Typically, the membrane 126 and the circuit board 110 will be substantially parallel (deviation less than 20 degrees) to each other and the sound producing portion of the membrane will be (a) within the magnetic field of the magnet of the stator assembly, and (b) positioned such that a current flowing through a coil induces a current in the at least part of the sound producing area in an amount effective to produce audible signal.

More particularly, and with further reference to FIG. 1, the transducer comprises a stator assembly 130 that includes a metal housing 132 and a magnet 134, wherein the housing and the magnet are preferably at least partially embedded in the printed circuit board 110. In the configuration of FIG. 1, the magnet and the housing are preferably configured such that magnetic field lines 136 occupy a space above the board between the magnet 134 and the (typically metallic) stator housing 132. In such configurations, the magnetic field lines are closed through the housing (which typically also includes openings). It should be particularly appreciated that in such and other configurations the conductive membrane is exposed to the magnetic field such that the field lines run at least in part parallel to the plane of the membrane and/or through the membrane.

In some aspects of the inventive subject matter, the coil 140 is formed by conductive traces that are deposited on a plurality of layers of circuit boards. Therefore, it should be appreciated that the coil 140 can be manufactured as part of the manufacturing process of the entire board 110. However, in alternative aspects of the inventive subject matter, the coil may also be preformed and placed into an appropriate opening in the board (e.g., the coil may then be electronically coupled to the conductive trace(s) via surface mount technology, automated soldering, solder baths, etc.). Regardless of the manner of forming the coil, it should be recognized that the coil is positioned such that current running through the coil will induce a corresponding current 128 in the electrically conductive sound producing portion of the membrane (in the example of FIG. 1, the sound producing portion is identical with the area of the membrane surrounded by the baffle). It should be especially appreciated that as this induced current is within the magnetic field 136 of magnet 134, membrane movement is caused by the force generated from the induced current 128 in the magnetic field 136.

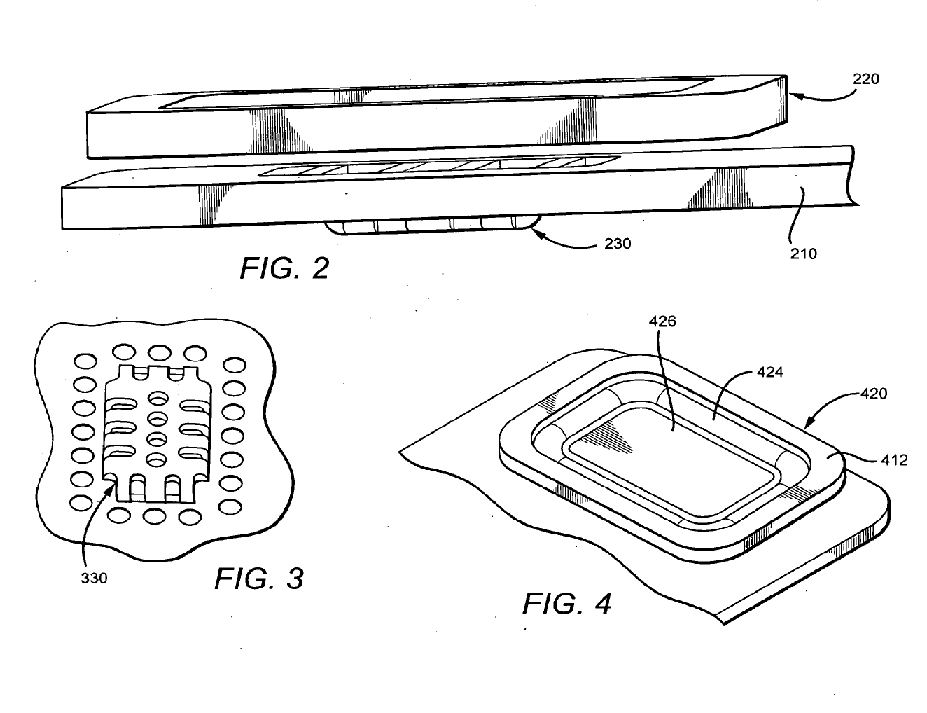

FIG. 2 depicts the arrangement of FIG. 1 in a perspective side view in which the membrane assembly 220 forms a sound producing portion and is “floating” above the printed circuit board 210 that carries the stator assembly 230, which forms the driver portion. Most typically, the membrane assembly 220 is coupled to a housing or other portion of the electronic device in which the transducer is located. FIG. 3 depicts a perspective bottom view of the stator assembly 330 with the stator housing extending from the printed circuit board (showing a portion of the coil through the opening of the stator housing) and with a plurality of openings in the assembly and circuit board. FIG. 4 shows a perspective top view of the membrane assembly 420 in which the mounting structure 412 (here configured as a rectangular frame) is coupled to a flexible baffle 424 that is coupled to rigid and conductive membrane 426 that forms the sound producing portion (as the membrane is rigid, the entire membrane is typically the sound producing portion).

Consequently, it is generally contemplated that a broadband transducer includes a floating, conductive, and rigid membrane that forms or comprises a sound producing area. As used herein, the term “floating” in conjunction with the term “membrane” refers to a manner of coupling the membrane to a mounting structure such as to allow the membrane at the point of coupling to move relative to the mounting structure. Most typically, movement of the membrane relative to the mounting structure at the point of coupling is substantially the same (i.e., +/−10%) as movement of the membrane in the center of the membrane. As also used herein, the term “conductive” in conjunction with the term “membrane” refers to a membrane that conducts electricity, most typically at a conductivity of equal or greater than 10,000 Sm-1. As still further used herein, the term “rigid” in conjunction with the term “membrane” refers to a membrane that has a Young's modulus of at least 10 GPa, and more preferably at least 100 GPa in at least one direction. Most typically, rigidity is of the membrane is isotropic.

Most preferably, the membrane is a thin sheet of a conductive material, wherein the actual dimensions and (and especially thickness) will be at least in part determined by the dimensions of the transducer, and desired sound pressure or sensitivity level. For example, where the transducer is configured as a speaker and/or microphone for a hand-held electronic device, the membrane may have an area of between 1 cm2 and 10 cm2 with a thickness of between 100-1000 micrometer (or even less). On the other hand, where the transducer is configured to produce substantial sound pressure levels (e.g., greater than 100 db), the membrane may have an area of between 100 cm2 and 1000 cm2 with a thickness of between 300-5000 micrometer (or even more). Consequently, it should be recognized that the specific dimensions of the membrane will predominantly be dictated by the specific use. However, it is generally preferred that the membranes will be configured as a flat sheet, and most typically the width and length will be at least 1000-fold the thickness of the membrane.

With respect to suitable materials, it is contemplated that the transducer membrane is preferably manufactured from a rigid and conductive metal, a metal alloy, and/or one or more composite materials. For example, especially suitable metals include silver, titanium, and copper that may be used as a conductive coating on a non-conductive material or that may be used in an unmodified form. Further especially suitable materials include metal alloys, and especially scandium and titanium alloys. Particularly suitable composite materials include those in which a synthetic polymer, carbon, or glass are employed as a rigid carrier to which a conductive portion is then coupled (e.g., U.S. Pat. No. 6,596,139). Such coupling may be done by intermingling, interweaving, or coating the carrier with the conductive material that may be applied as a sheet, a vapor, or by a plating process. Typically, the membrane is formed from a single piece and will be relatively rigid, and will therefore not deform under sound producing conditions to a degree that produces audible distortion). In still further contemplated aspects of the inventive subject matter, multiple membrane segments are also considered and/or membranes that are electrically conductive in only portions thereof.

While not limiting to the inventive subject matter, it is generally preferred that the membrane is coupled to a frame or other static structure to form a membrane assembly such that the membrane can move relative to the frame, and most preferably such that the membrane is a floating membrane. As there are numerous manners of coupling the membrane to the frame or static structure, it should be appreciated that the particular configuration of contemplated membrane assemblies may vary considerably. However, it is generally preferred that at least a portion of the conductive and/or sound producing area of the membrane is exposed to the magnetic field of the magnet in the stator assembly and that a current can be induced by the voice coil of the stator assembly in the conductive and/or sound producing area producing area. For example, it is generally preferred that the frame or other static structure at least partially surrounds the membrane and that a baffle, elastic connectors, and/or other flexible elements (even including flexible extensions of the membrane) will movably couple the membrane to the frame or structure. Consequently, especially suitable frames include round, rectangular, or irregularly shaped formed to surround the edge of the membrane. It should therefore be noted that the membrane in such membrane assemblies produces sound by homogenous movement of the entire sound producing area (typically the entire membrane) rather than by deformation of the membrane, thus allowing formation of a broadband transducer. Viewed from a different perspective, the membrane is coupled to a mounting structure such that the edges of the sound producing portion will have substantially the same range of motion than the center of the membrane. The membrane assembly may be then coupled to the circuit board, the housing of an electronic device, or may have other structures to allow fixed positioning of the membrane relative to the stator assembly. Thus, the sound producing portion (i.e., conductive portion of the membrane) may be coupled to a housing of the device or may even form part of a housing of the device.

In still further aspects of the inventive subject matter, it should be recognized that the transducer may have a conductive membrane (or other conductive portion) that is entirely independent from the stator assembly. Indeed, in such transducer devices it is contemplated that the only requirement for the membrane is conductivity. For example, the membrane may be formed from a window pane onto which a conductive tape or other coating is applied. Once a stator assembly is placed in proximity to the conductive tape or coating (and vibrationally uncoupled from the window pane), the pane will act as a large scale membrane and vibrations in the pane will include a current in the voice coil, thus transforming the pane into a microphone. Therefore, it should be appreciated that contemplated transducers may be employed to measure dynamic movement of any two (or more) independently moving objects.

Contemplated stator assemblies typically include a voice coil, a magnet, and a stator housing, while most minimal configurations include a magnet and a voice coil, wherein the magnet is positioned relative to the membrane such that at least part of the sound producing area is disposed in a magnetic field of the magnet, and wherein the voice coil is positioned relative to the magnet such that when current flows through the coil a current can be induced in the sound producing area in an amount effective to produce an audible broadband signal. In particularly preferred aspects, the stator assembly comprises a stator housing coupled to the magnet, wherein the magnet is disposed within an annular or rectangular space formed by the coil, and wherein the housing is configured to close/concentrate magnetic field lines below the membrane.

It is still further particularly preferred that the coil is coupled to or at least partially embedded within the printed circuit board of the electronic device that comprises the transducer. Consequently, the coil may be formed by a plurality of conductive elements in a plurality of layers forming the printed circuit board (e.g., in a multi-layer circuit board the coil may be formed from traces on the layers wherein the traces are electrically coupled to each other such as to form a coil). Alternatively, it is also contemplated that the circuit board may be a single board, or have a layer number (e.g., two or three layers) that would not be suitable for formation of a coil as needed herein. Thus, it should be appreciated that the coil may also be a preformed coil that is then electrically coupled to the printed circuit board in conventional manner (using solder points, wires, or SMD technology). Furthermore, it is contemplated that the coil may be energized by one or more circuits within the electronic device, or that external amplifiers may be employed. Of course, and where desired, multiple coils may be used for induction in the transducer membrane. Regardless of the number and arrangement of the coils, it is generally preferred that the coil is configured to allow operation of the coil as a voice coil for a speaker or a voice coil in a microphone.

With respect to the magnet it is contemplated that the magnet is coupled to or at least partially embedded within the circuit board. The magnet is most preferably a relatively strong and permanent magnet (e.g., rare earth magnet), but may also be configured as an electromagnet, most typically with a core. Alternatively, it should be appreciated that the magnet in contemplated speakers may also be formed in a magnetization step during or after completion of the circuit board. In preferred aspects, the magnet is a single bar magnet that surrounded by the coil, however, two or more magnets are also deemed suitable. In still further aspects, one or more U-shaped magnets may be used, which may advantageously allow omission of a stator housing. On the other hand, where one or multiple bar magnets are used, the housing is preferably shaped such that the magnetic field is closed through the housing at the side opposite the membrane. Therefore, the shape of suitable magnets may vary considerably and all known shapes, including ring-shapes, disk shapes, bar shapes, etc. are deemed suitable. It is further preferred (but not needed) that the magnet has one or more openings. Additionally, it should be recognized that the magnet need not be a permanent magnet, but may be magnetized in the process of assembly of the electronic device.

Consequently, and viewed from a different perspective, an electronic device will include a broadband transducer having a driver portion and a sound producing portion, wherein the driver portion and sound producing portion are independent (i.e., operable to produce sound even when driver portion and sound producing portion are not physically coupled to each other). In such electronic devices, it is further preferred that the driver portion is configured and positioned relative to the sound producing portion such that the driver portion allows induction of a current in the sound producing portion to thereby effect an audible broadband signal. Furthermore, it is contemplated that the device includes a printed circuit board with a plurality of conductive traces, wherein at least one of the traces is electronically coupled to the driver portion. Among other suitable uses, it is especially preferred that the electronic device is a microphone, an audio speaker, a phone, a vibrometer, a dynamic force gauge, or a sonar transducer (the stator assembly in such devices is then typically insulated by a thin layer of non-conducting material).

Therefore, the inventors also contemplate a method of manufacturing an intermediate in the production of an electronic device (the device will typically include a broadband transducer that includes a driver portion and a sound producing portion), wherein the method comprises a step of providing a printed circuit board having a plurality of conductive traces. In another step, a driver portion (e.g., comprising a voice coil, a permanent magnet, and a stator housing coupled to each other) is electronically coupled without the sound producing portion to one or more of the conductive traces of the printed circuit board. In some methods, the driver portion comprises a prefabricated voice coil, and/or the driver portion comprises a voice coil that is at least partially embedded in the printed circuit board (e.g., the voice coil is formed by a plurality of conductive elements in a plurality of layers forming the printed circuit board). Typically, the voice coil circumferentially encloses a magnet. It is also preferred that the sound producing portion is positioned in proximity to the driver portion to thereby form a broadband planar magnetic induction transducer. The circuit board is typically not dedicated to production of the transducer, but predominantly serves as a basis for the components of contemplated electronic devices that also include the transducer. Where desired, the circuit board may have a plurality of openings to allow for dipolar character of the speaker. However, in at least some aspects (e.g., where cardioid or other character is desired), no openings may be implemented.

Thus, specific embodiments and applications and methods related to planar magnetic broadband induction transducers have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting the specification and contemplated claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. A broadband transducer comprising:
a floating conductive and rigid membrane having a sound producing area;
a stator assembly comprising a magnet and positioned relative to the membrane such that at least part of the sound producing area is disposed in a magnetic field of the magnet; and
a voice coil positioned relative to the magnet such that when current flows through the coil a current can be induced in the at least part of the sound producing area in an amount effective to produce an audible broadband signal.

2. The transducer of claim 1 wherein the stator assembly comprises a stator housing coupled to the magnet.

3. The transducer of claim 1 wherein the magnet is disposed within an annular or rectangular space formed by the coil.

4. The transducer of claim 1 wherein the coil is coupled to or at least partially embedded within a printed circuit board.

5. The transducer of claim 4 wherein the coil is formed by a plurality of conductive elements in a plurality of layers forming the printed circuit board.

6. The transducer of claim 4 wherein the magnet is coupled to or at least partially embedded within the circuit board.

7. The transducer of claim 4 wherein at least one of the circuit board and the magnet includes a plurality of openings.

8. The transducer of claim 1 further comprising a frame to which the membrane is coupled.

9. A method of manufacturing an intermediate in the production of an electronic device having a broadband transducer that includes a driver portion and a sound producing portion, the method comprising;
providing a printed circuit board having a plurality of conductive traces; and
electronically coupling a driver portion without the sound producing portion to at least one of the conductive traces of the printed circuit board.

10. The method of claim 9 wherein the driver portion comprises a prefabricated voice coil.

11. The method of claim 9 wherein the driver portion comprises a voice coil that is at least partially embedded in the printed circuit board.

12. The method of claim 11 wherein the voice coil is formed by a plurality of conductive elements in a plurality of layers forming the printed circuit board.

13. The method of claim 11 wherein the voice coil circumferentially encloses a magnet.

14. The method of claim 9 wherein the driver portion comprises a voice coil, a permanent magnet, and a stator housing coupled to each other.

15. The method of claim 9 further comprising positioning the sound producing portion in proximity to the driver portion to thereby form a broadband planar magnetic induction transducer.

16. The method of claim 15 wherein the sound producing portion comprises a conductive metallic membrane that is optionally part of a housing of the device.

17. An electronic device comprising:
a broadband transducer having a driver portion and a sound producing portion, wherein the driver portion and sound producing portion are independent;
wherein the driver portion is configured and positioned relative to the sound producing portion such that the driver portion allows induction of a current in the sound producing portion to thereby effect an audible broadband signal; and
a printed circuit board with a plurality of conductive traces, wherein at least one of the traces is electronically coupled to the driver portion.

18. The electronic device of claim 17 wherein the driving portion is coupled to or at least partially embedded in the circuit board, and optionally, wherein the sound producing portion is coupled to a housing of the device.

19. The electronic device of claim 17 configured to operate as a device selected from the group consisting of a microphone, a speaker, a telephone, a vibrometer, a dynamic force gauge, and a sonar transducer.

20. The electronic device of claim 17 wherein the broad band transducer has a frequency response with a deviation of equal or less than 12 db over a range of between 100 Hz and 10 kHz.
